(19) United States
(12) Patent Application Publication
(10) Pub. No.: US 2006/0210760 A1
(43) Pub. Date: Sep. 21, 2006

(54) Phase change type optical information recording medium

(76) Inventor: Shinya Narumi, Yokohama-shi (JP)

Correspondence Address: COOPER & DUNHAM, LLP, 1185 AVENUE OF THE AMERICAS, NEW YORK, NY, 10036, US

(21) Appl. No.: 11/378,901

(22) Filed: Mar. 16, 2006

(30) Foreign Application Priority Data
Mar. 17, 2005 (JP) 2005-078101

(51) Int. Cl. B32B 3/02

(52) U.S. Cl. 428/64.4

(57) ABSTRACT

A phase change optical information-recording medium includes a substrate, a bottom protection layer, a recordation layer, a top protection layer, and a reflection layer, each formed on the substrate in that order. The reflection layer mainly includes Ag, and the top protection layer mainly includes oxide and nitride or carbide.

### FIELD OF THE DISCLOSURE

The present invention relates to an optical information recording medium that records and reproduces information at high speed with high density using an optical device, such as a laser light, etc. In particular, the present disclosure relates to an optical information recording medium including a dielectric protection layer that employs an element not having high lability to Ag so as to suppress deterioration of a reflection layer, which is caused due to reaction to a component of the dielectric protection layer when Ag-included heat conductive material is employed in the reflection layer in order to record at high speed.

### BACKGROUND

A phase change type information-recording medium among rewritable-type optical information recording media is typically configured to functionally include a protection layer, a recordation layer, a protection layer, and a reflection layer. These layers generally include a transparent resin, a dielectric material, a chalcogen type phase change recordation material, a dielectric material, an Al or Ag type pure metal or alloy, respectively. The chalcogen type phase change recordation material changes between crystal and amorphous in accordance with heat history, and is capable of representing recorded information in accordance with a difference in a reflection rate. A phase change type optical information-recording medium has recently become more frequently used and high density and high linear speed writing is increasingly demanded. Among various proposed high density technologies, one proposes to use a semiconductor laser having a short wavelength and a large NA (Numerical Aperture: Number of openings) of an optical pickup so as to narrow down a recordation laser beam for executing high density recordation, as discussed in PCT International Application Publication No. 99/00794.

The reflection layer plays an important role in a high linear speed technology, and is expected to maintain a high reflection rate with a high cooling speed. Thus, high heat conductive material, such as Ag, Au, Cu, etc., is chosen. In particular, the Ag is frequently employed in the reflection layer.

However, a reflection layer of Ag is chemically active to some non-metal elements, such as chlorine, sulfur, etc., and ions thereof, thereby causing material degradation and leaving the recording medium susceptible to environmental effects. To resolve such problems, it has been proposed that a metal element, such as 0.1 to 5.0% Au, etc., is mixed with the Ag as an impurity, such as discussed in Japanese Patent Application Laid Open No. 2002-129260.

When an Ag type material is employed in the reflection layer it is desirable to selectively choose the other layers. For example, heat and optical performances as well as productivity (i.e., a film formation speed) are regarded as important properties for material used in the dielectric layer. ZnS.SiO₂ (80:20 mol %) is often used due to it ability to meet these conditions. However, when a material having high reflectivity and heat conductivity mainly including Ag is used to form a reflection layer, corrosion due to the sulfur included in the dielectric layer occurs. As a countermeasure, it has been proposed that an intermediate layer made of metal or semiconductor oxide, nitride, carbide, or amorphous carbide is arranged between a dielectric layer including a sulfur element and a reflection layer mainly having Ag so as to prevent the corrosion of the Ag reflection layer as discussed in Japanese Patent Application Laid Open No. 11-238253.

Further, to avoid sulfurization of a reflection layer material, a barrier layer having a nitride, an oxide, a carbide or a nitrogen oxide of an element, such as Sn, In, Zr, Si, Cr, Al, Ta, V, Nb, Mo, W, Ti, Mg, Ge, etc., is arranged between a dielectric layer and a reflection layer, such as discussed in Japanese Patent Application Laid Open 2002-74746 and Japanese Patent Application Laid Open No. 11-238253.

As a more preferable barrier layer than that in Japanese Patent Application Laid Open Nos. 11-238253 and 2002-74746, a barrier layer made of a mixture of oxide and nitride including at least metal chosen from Ti, Zr, V, Nb, Ta, Cr, Mo, and W is proposed in Japanese Patent Application Laid Open No. 2004-185794.

However, while the above-mentioned methods insert another layer between the dielectric layer of ZnS.SiO₂ and the reflection layer that includes Ag as a main component so as to avoid direct contact between the dielectric layer and the reflection layer, corrosion unavoidably occurs in the reflection layer when a barrier layer or intermediate layer is not adequately formed between the dielectric layer or is significantly deteriorated by some reasons. Accordingly, it is preferred that the dielectric layer excludes material having high lability to Ag, such as chlorine, sulfur, etc., and therefore can directly contact a reflection layer mainly including the Ag, without intermediate and barrier layers therebetween, to avoid Ag corrosion.

Therefore, the following examples of dielectric layer materials excluding sulfur have been proposed: oxides of Ta, Ti, Zr, Al, Si, and Ge, and a mixture thereof; nitrides of Ta, Zr, Al, Si, and Ge; one of a ZnO elementary substance and a mixture oxide of ZnO and Al₂O₃, the above-mentioned nitrides, a ZnO-elementary substance, mixture prepared by optionally choosing from mixture oxides, as discussed in Japanese Patent Application Laid Open No. 2001-100076; material having ZnO as a main component, as discussed in Japanese Patent Application Laid Open No. 2002-237095; mixture of at least one of SiC, Zr, Ti, Ta, and Nb, as discussed in Japanese Patent Application Laid Open No. 2002-269824; Te oxide, oxide of Te and another metal, material mainly having mixture of oxide and nitride as discussed in Japanese Patent Application Laid Open No. 2002-298436; mixture of cerium oxide and another oxide, such as chromic oxide, ferric oxide, manganese oxide, niobium oxide, magnesium oxide, zinc oxide, aluminum oxide, titanium oxide, yttrium oxide, tantalum oxide, antimony oxide, zirconium oxide, and bismuth oxide, as discussed in Japanese Patent Application Laid Open No. 2003-166052; and mixture of ZrO₂, SiO₂, TiO₂, and Y₂O₃, CeO, Al₂O₃, MgO, CaO, Nb₂O₅ as well as at least one of rare earth oxides, as discussed in Japanese Patent Application Laid Open No. 2004-5767.

However, further improvements in dielectric material are needed.

### SUMMARY

This disclosure provides examples of novel phase change optical information-recording media. In one example, a phase change optical recording medium includes a substrate, and a bottom protection layer, a recording layer, a top protection layer and an Ag-type reflective layer formed on the substrate in the recited order. The top protection layer includes oxide as a main component and nitride or carbide.

In another example, a phase change optical recording medium includes a substrate having a wobble guide groove in a concentric or spiral shape, a bottom protection layer, a recordation layer, a top protection layer, and a reflection layer formed on the substrate one after another. A phase of the recordation layer can be changed by emission of a semiconductor laser light when information is to be recorded or rewritten. The reflection layer mainly includes Ag, and the top protection layer includes oxide as a main component and one of nitride and carbide.

In another embodiment, the oxide includes an element having binding energy of 90 kj/mol for binding the element and oxygen.

In yet another embodiment, the oxide includes one of ZnO, In₂O₃, and TeO₂.

In yet another embodiment, a content of the oxide is more than 50 mol %

### BRIEF DESCRIPTION OF DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 illustrates a layer configuration of a phase change type optical information recording medium according to an exemplary embodiment of the present disclosure; and

FIGS. 2A to 3B are tables showing practical and comparative examples according to several exemplary embodiments of the present disclosure.

### DESCRIPTION OF PREFERRED EMBODIMENTS

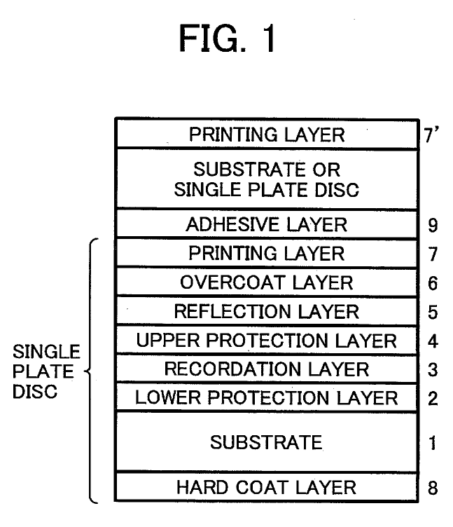

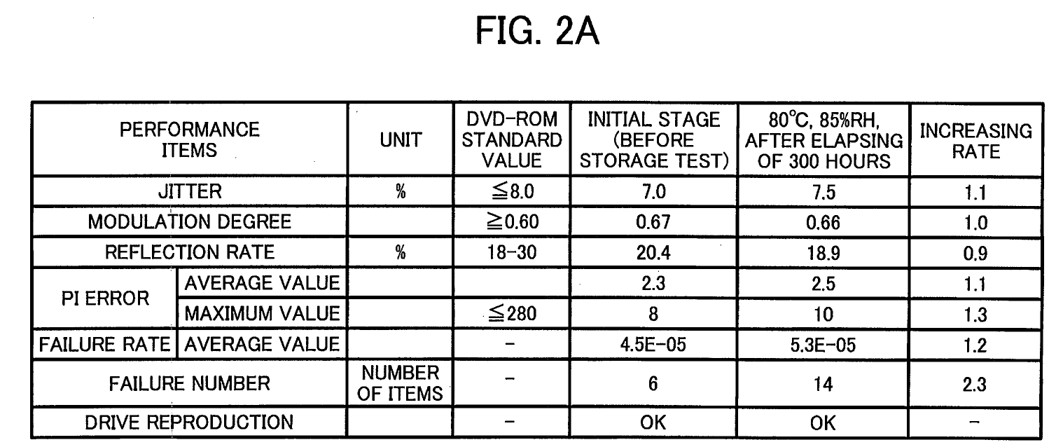

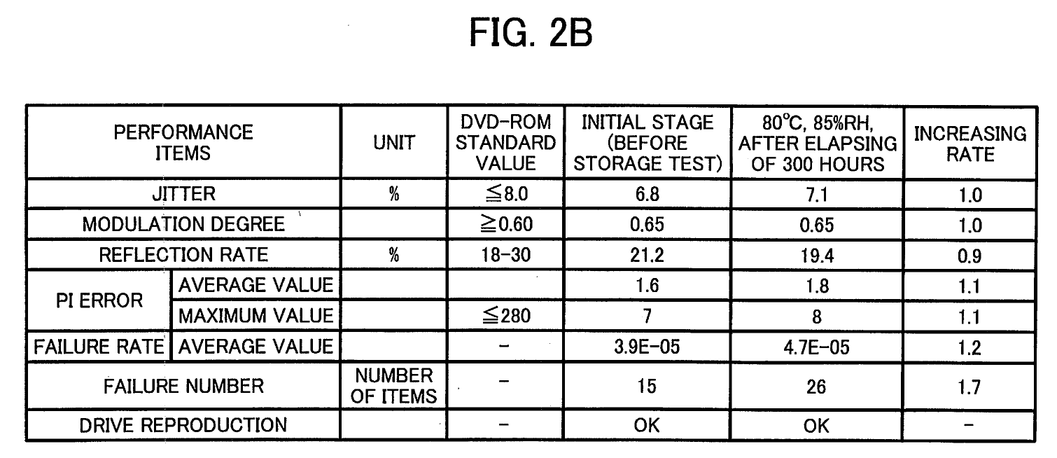

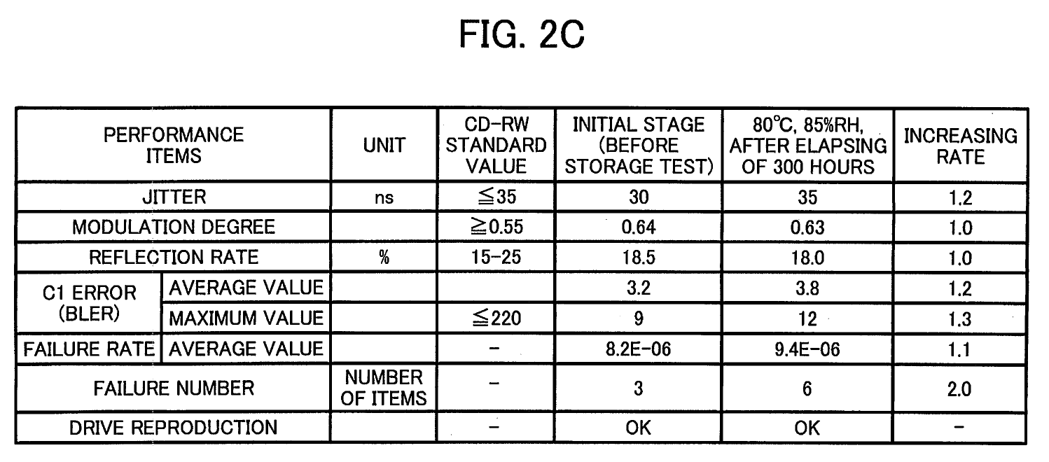

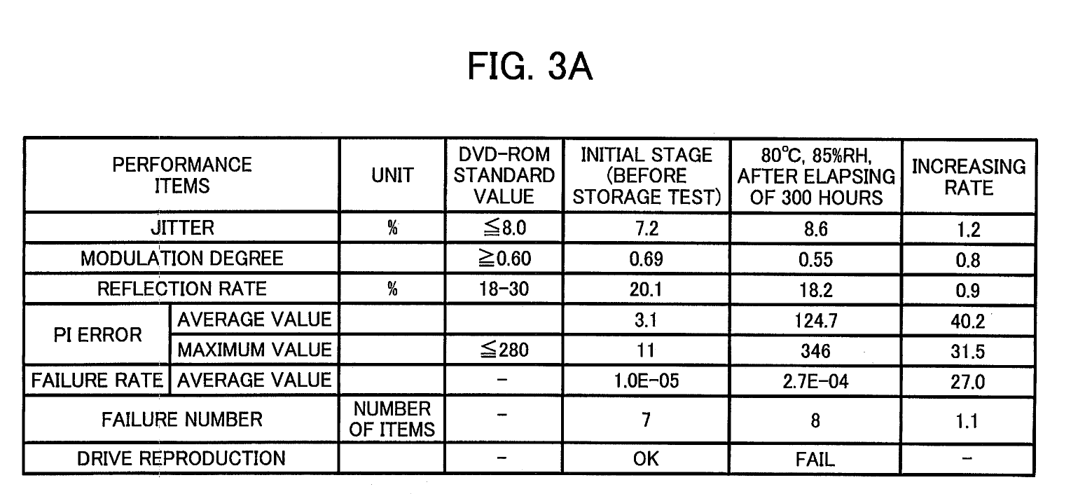

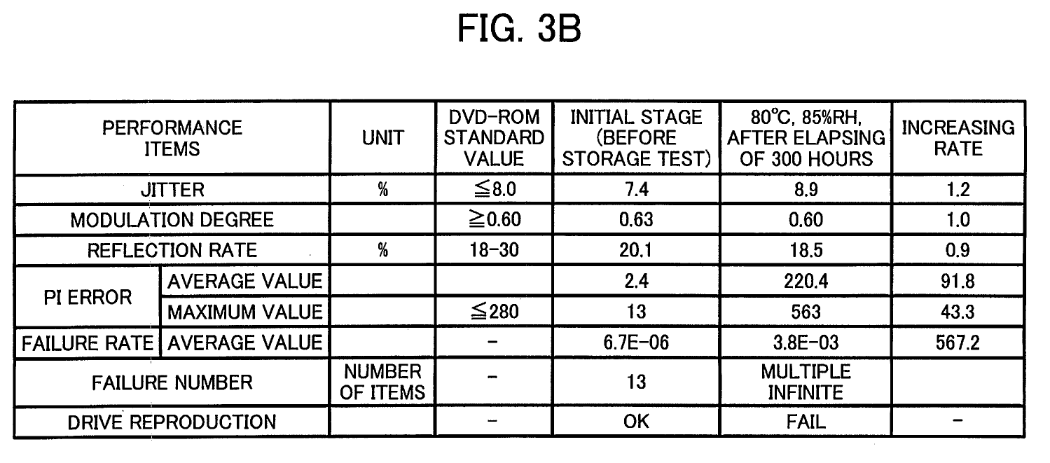

Referring now to the drawing, wherein like reference numerals designate identical or corresponding parts throughout several views, in particular to FIG. 1, an exemplary layer configuration of a phase change type optical information-recording medium according to an exemplary embodiment of the present disclosure is illustrated.

When the phase change type optical information-recording medium is a rewritable medium, it basically includes a transparent substrate 1 having a guide groove, a bottom protection layer 2, a recordation layer made of phase change material, a top protection layer 4, and a reflection layer 5. One or more additional layers can optionally be included. For example, an overcoat layer 6 may be formed on the reflection layer. A printing layer 7 can be arranged on the overcoat layer 6. A hard coat layer 8 can be arranged on a mirror surface side of the substrate 1. Further, the above-mentioned single plate disc can be laminated with a transparent substrate or the other same single plate disc via an adhesive layer 9. Further, a printing layer 7′ can be formed on the opposite side after the lamination.

The substrate can be made of one of a normal glass, a ceramics, and a resin, and is preferably a resin substrate in view of a molding performance and cost. As a resin, polycarbonate resin, acrylic resin, epoxy resin, polyethylene resin, achryl-nitryl styrene copolymer resin, polyethylene resin, polypro resin, silicone type resin, fluoric type resin, ABS resin, and urethane resin are exemplified. In view of molding and optical performances, as well as cost, the polycarbonate resin and acrylic resin are preferable. Preformat information can be encoded while wobbling a guide groove to be formed on the substrate and using modulation of the wobbling. Especially, a wobbling encode method using phase modulation system as employed in a DVD+RW is excellent in productivity as discussed in Japanese Patent Application Laid Open No. 10-69646, because the previously format information is formed together with address information when a substrate is produced thereby a special ROM pit does not need to be formed like in a prepit method. In addition, if a wobbling frequency around 820 MHz is used for a DVD+RW, positioning precision of an address is more preferably improved.

As material of a phase change recordation layer used in a rewritable phase change type optical information recording medium, a phase change type recordation material including Sb and Te, which causes phase change between a crystal and an amorphous and is capable of taking stable or quasi-stable states, is preferable. That is, recordation (making into amorphous) sensitivity and speed, erase (crystallization) sensitivity and speed, and an erase ratio are excellent. By adding an element, such as Ga, Ge, Ag, In, Bi, C, N, O, Si, S, etc., to this SbTe material, recordation and erase sensitivities, a signal performance, and credibility are improved. Thus, it is preferable that a composition ratio of an additional element and material is adjusted in accordance with a recordation linear speed and a linear speed region as targets, and thereby the recordation linear speed is optimized, while maintaining reproduction stability and a life (i.e., credibility) of a recordation signal.

In a phase change type optical information recording medium according to one embodiment of the present disclosure, material of a recordation layer preferably totally meets these performances and the below described inequalities, if it includes component elements of Ag and/or Ge, Ga and/or In, Sb, and Te, wherein a component formula is represented as (Ag and/or Ge)α(Ga and/or In)βSbγTeδ, and wherein α, β, γ and δ represent atomic %, and α+β+γ+δ=100.

| | | | |
|---|---|---|---|
| 0 < α ≦ 6 | 2 ≦ β ≦ 10 | 60 ≦ γ ≦ 85 | 15 ≦ δ ≦ 27 |

A film thickness of the phase change type recordation layer is preferably from 5 to 40 nm.

Considering an initial performance of jitter, an overwrite performance, and mass productivity, the thickness is more preferably from 10 to 25 nm. Specifically, if the thickness is less than 5 nm, a light absorption performance is significantly deteriorates, and does not take a role of the recordation layer.

If it is more than 40 nm, on the other hand, high speed and uniform phase change is difficult to occur.

Such a phase change type recordation layer can be produced by various vapor phase growing methods, such as a vacuum deposition method, a sputtering method, a plasma CVD method, an optical CVD method, an ion plating method, and an electronic beam deposition method, etc.

The sputtering method is most preferable due to excellence in mass productivity and film quality or the like.

Protection layers are formed on the bottom and top layers of the phase change type recordation layer. A reflection layer is further formed on the top layer. The reflection layer includes metal material, such as Al, Au, Ag, Cu, Ta, Ti, W, etc., or alloy including these elements. In order to improve corrosion fatigue resistance and heat conductivity or the like, an element, such as Cr, Ti, Si, Cu, Ag, Pd, Ta, etc., can be added to the above-mentioned material. Such a reflection layer can be produced by various vapor phase growing methods, such as a vacuum deposition method, a sputtering method, a plasma CVD method, an optical CVD method, an ion plating method, and an electronic beam deposition method, etc. Among those, Ag or Au type material having higher heat conductivity than the other is preferable in view of high-speed recordation, because the material can more quickly cool the recordation layer after the reflection layer increases temperature. Especially, when a phase change type optical information recording medium that needs recordation in a high linear speed region, such as ten times speed of a CD-ROM (e.g. 12 m/s), four times speed of a DVD-ROM (e.g. 14 m/s), etc., is used, Ag or Ag type alloy mainly including Ag is more preferable than Au in view of manufacturing cost.

However, admitting that the Ag type material avoids a problem of a corrosion fatigue resistance, the Ag reflection layer or the Ag type alloy reflection layer mainly having Ag sometimes causes film defect due to fluidity of the Ag when flowage of the Ag can't be suppressed by the neighboring top protection layer and the overcoat layer while the optical information recording medium is left under high temperature or humidity environment. Thus, a defection rate is preferably suppressed to be not more than 1.0×10⁻⁴ to use an optical information recording medium without reproduction error even when it is left over in the high temperature and humidity environment. If the defect rate and reproduction error increase rate are high under the high temperature and humidity environment, the optical information-recording medium possibly causes a problem when preserved for a long time and is then reproduced. Thus, it is preferable if the defection and reproduction error increase rates are relatively low. However, it is expected that three times are not exceeded even if the optical information-recording medium is left for 300 hours under temperature of 80 degree centigrade and relative humidity of 85% RH. As a film thickness of the reflection layer made of the above-mentioned metal or alloy, 50 to 200 nm especially 70 to 160 nm, is preferable. The metal layer or the alloy layer can be multiple. When they are made multiple, a thickness of each layer needs at least 10 nm, and the total film thickness of the multiple layers is preferably 50 to 160 nm.

As material of the protection layer, nitride, such as Si₃N₄, AlN, TiN, BN, ZrN, etc., sulfur, such as ZnS, In₂S₃, TaS₄, etc., these mixtures, oxide of nitride or sulfur, such as SiO, SiO₂, ZnO, SnO₂, Al₂O₃, TiO₂, TeO₂, In₂O₃, MgO, ZrO₂, etc., carbide, such as SiC, TaC, BC, WC, TiC, ZrC, etc., and mixture with diamond state carbon are exemplified. Impurity can be included upon need. Laminate can include more than two layers rather than a single layer. However, a melting point of the protection layer needs to be higher than that of the phase change type recordation layer. Such a protection layer can be produced by various vapor phase growing methods, such as a vacuum deposition method, a sputtering method, a plasma CVD method, an optical CVD method, an ion plating method, and an electronic beam deposition method or the like. The sputtering method is most preferable among those due to excellence in mass productivity and film quality, or the like. The thickness of the protection layer largely affects a reflection rate, a modulation rate, and recordation sensitivity.

To meet these performances, the thickness of the bottom protection layer needs to be 30 to 200 nm.

To obtain preferable signal performance, the thickness is preferably from 40 to 100 nm.

In the phase change type optical information-recording medium according to one embodiment of the present disclosure, material of the top protection layer includes oxide as a main component and nitride or carbide. The reason for mainly using the oxide is to secure contact with the reflection layer including the Ag or Ag type material mainly including the Ag. Generally, the oxide is excellent in contact with the reflection layer of the Ag type material more than hard material of nitride, such as Si₃N₄, AlN, etc., and carbide, such as SiC, ZrC, etc. The oxide can be an elementary substance chemical compound or a mixture or a chemical compound of more than two types of oxides. However, to secure the contact, the oxide needs to totally include more than 50 mol %. More preferably, more than 70 mol % is included. When a rate of inclusion of the nitride or the carbide increases, contact with the reflection layer made of Ag or Ag type material mainly including the Ag decreases, and a film sometimes peels off under the high temperature and humidity. Sulfide is not preferably included in the top protection layer due to Ag corrosion as mentioned earlier.

However, when the oxide is used, a film formation rate is low during sputtering and takes a longer time period in comparison with that using the nitride or the carbide. When the film formation time period is long, production process becomes slow, thereby production efficiency deteriorates and cost increases. Further, if the film formation time period is too long, deformation occurs due to temperature increase in the substrate during the film formation. Thus, material capable of easily braking combination having a relatively high speed-sputtering rate is preferable, such as an oxide of an element having low binding energy for binding the element and oxygen. Preferably, material includes binding energy less than 90 kl/mol, such as ZnO, In₂O₃, TeO₂, etc. Since the binding energy is enough if being low, there is no lowest limitation. A mixture of oxide and nitride or carbide is produced by adding material, such as a nitride of an element having high binding energy for binding an element and nitrogen, carbide of an element having high binding energy for binding an element and carbon, etc., because it is stable as a chemical compound and hardly produces a chemical compound compatible with the oxide as a main component. Thus produced mixture can significantly decrease heat conductivity. If the additional nitride or carbide is more stable, the nitride of the element having higher binding energy for binding the element and the nitrogen, as well as the carbide of the element having higher binding energy for binding the element and the carbon is preferable, because the additional nitride or the carbide hardly produces a chemical compound compatible with the oxide serving as main material. Such material preferably includes the binding energy of more than 100 kj/mol, such as Si₃N₄, TiN, ZrN, SiC, TiC, ZrC, etc.

As a method of film formation of the top protection layer, the sputtering method is preferable in view excellence in mass productivity and film quality or the like. Especially, when a layer made of a mixture of several chemical compounds is to be formed, a film is preferably formed from a target having the same material ratio to that of the protection layer using the sputtering method than that is formed from a metal target or a metal carbide target under an ambient provided with oxygen gas or nitrogen gas to obtain metal oxide or nitride, a mixture of metal oxide and carbide, or a mixture of carbide and nitride using a reaction performance sputtering method. That is because, a protection layer having an expected material ratio can be stably formed. The thickness of the top protection layer is 5 to 40 nm, preferably 10 to 25 nm. If the thickness is less than 5 nm, the protection layer doesn't work as a heat resistance, and recordation sensitivity deteriorates. If the thickness is more than 40 nm, a boundary face tends to peel off and repetitious recordation performance deteriorates.

If a film formation time period is long during sputtering, the above-mentioned problems of production cost and substrate deformation occur. However, if the film formation time period is too short, a film thickness is hardly controlled, and varies between items, thereby stable production is hardly executed. Thus, the film formation time is preferably 2 to 15 seconds, more preferably 4 to 10 seconds. Accordingly, a sputtering rate is preferably 0.33 to 20 nm/second, more preferably 1 to 6.25 nm/second.

An overcoat layer is formed on the reflection layer to avoid corrosion. Ultraviolet light curable type resin produced by spin coat is generally used to form the overcoat layer. The thickness thereof is preferably 3 to 15 micrometer. If the thickness is less than 3 micrometer and a printing layer is formed on the overcoat layer, a number of errors possibly increases. If the thickness is more than 15 micrometer, stress increases and largely affects machine performance of a disc. As a hard coat layer, ultraviolet light curable type resin produced by spin coat is generally used. The thickness thereof is preferably 2 to 6 micrometer. If the thickness is less than 2 micrometer, abrasion resistance is insufficient. If the thickness is more than 6 micrometer, stress increases and largely affects machine performance of a disc. Thus, hardness needs more than the level “H” in pencil hardness not to allow large cut when rubbed with cloth. Upon need, blending conductive material effectively prevents charge and accordingly attraction of dust or the like. The printing layer is provided to secure an abrasion performance and form an ink reception layer for label printing of a brand name or the like and ink jet printing. Ultraviolet light curable type resin is generally used to form the printing layer using a screen-printing method. The thickness is preferably 3 to 50 micrometer. If the thickness is less than 3 micrometer, a layer becomes uneven during formation.

If the thickness is more than 50 micrometer, stress increases and largely affects machine performance of a disc.

As an adhesive layer, adhesive, such as ultraviolet light curable type resin, hot melt adhesive, silicone resin, etc., can be used. Such material of the adhesive layer is coated on the overcoat layer or the printing layer using spin coat, roll coat, and screen printing methods in accordance with the material, and undergoes processing, such as ultraviolet light emission, heating, pressure applying, etc. Then, the disc is adhered to a second disc such that the adhesive layer is contacted to the opposite surface of the second disc. The opposite surface disc can be a single plate similar to the above-mentioned respective layers or a transparent substrate. Material of an adhesive layer does not always need to be coated on a laminate surface for the opposite surface disc. As the adhesive layer, a tacky adhesion sheet can be employed. A film thickness of the adhesive layer is not limited, but is preferably 5 to 100 micrometer considering influence to coating and hardening performances of material and machine performance of a disc. A range of the adhesive surface is not limited, but a position of an inner peripheral end is preferably distanced by 15 to 40 mm, more preferably 15 to 30 mm, to secure prescribed adhesion intensity, when applied to an optical information recording medium capable of DVD and/or CD conversion.

Several practical examples are now described.

A first practical example was herein below described. A polycarbonate substrate with a wobbling guide groove having a diameter of 120 mm and a thickness of 0.6 mm was produced using an injection molding method. A bottom protection layer, a phase change recordation layer, a top protection layer, and a reflection layer were laminated on the substrate one after another using a sputtering method.

(ZnS)₈₀(SiO₂)₂₀, phase change recordation material of Ag₁Ge₃In₄Sb₇₂Te₂₀, (ZnO)₇₀(Si₃N₄)₃₀, and a target of Ag were used for the respective layers and underwent sputtering. Film thicknesses were 60, 15, 15, and 140 nm, respectively, in this order from the substrate side. A film formation time period for the top protection layer was 8.0 second. A sputtering rate was 15/8 (i.e., 1.9) nm/sec.

An overcoat layer made of ultraviolet light resin having an average film thickness of 6 micrometer was formed on the reflection layer using a spin coat method. Thereby, a single plate of a phase change type optical information recording medium having a DVD-ROM reproduction compatibility was produced. Then, a polycarbonate substrate having a thickness of 0.6 mm was laminated with the overcoat layer via an adhesive layer made of ultraviolet light curable type resin having an average film thickness of 50 micrometer formed using a spin coat method. Thereby, a lamination disc having a thickness of 1.2 mm was obtained. Then, the recordation layer was crystallized over the entire surface by an initialization apparatus having a large caliber LD (e.g. beam diameter: 75×1 micrometer) while executing constant liner velocity rotational control on conditions that a linear speed was 11 m/s, a feeding amount was 36 micrometer/round, and an initialization laser power was 1300 mW.

Content data were then recorded into the thus obtained optical disc having the DVD-ROM compatibility using an optical information recordation apparatus capable of handling the DVD (e.g. MP 5240A manufactured by Ricoh Co. Ltd.) at a linear speed corresponding to a DVD-ROM four times speed (i.e., 14 m/s). A performance of this recordation section was evaluated using a DVD recordation evaluation apparatus (e.g. CATS SA300 manufactured by Audio Development Co, Ltd.,) as shown in a first table. Specifically, a jitter performance (data to clock jitter) was 7.0% (a DVD-ROM standard is less than 8%), a modulation level was 0.67 (a DVD-ROM standard is more than 0.6), a reflection rate was 20.4% (a double layer system DVD-ROM standard is 18 to 30%), an average of PI error was 2.3, and the maximum of PI error was 8 (a DVD-ROM standard is less than 280. Thus, recordation was preferably performed. When the recorded content data were read from the optical disc using a DVD-ROM recordation apparatus (e.g. MP 9120A manufactured by Ricoh Co. Ltd.), data could successfully be read without error. Further, a defection rate measurement apparatus measured an optical disc manufactured by the same condition, a defective rate was 4.5×10⁻⁵.

A number of spots allowing transmission of incandescent light were six over the entire disc surface when visual check was executed. The defective rate is discussed in detail in Japanese Patent Application Laid Open No. 2002-260224, herein incorporated by reference, and is defined as a ratio of portions having reflection light intensity outside of a prescribed range including the average reflection light intensity as the center thereof. When these optical discs were preserved in a high temperature and humidity environment of 80 degree centigrade and 80% RH for 300 hours, and were visually checked, a black spot or the like caused by corrosion of the Ag reflection layer and a float or peeling off was not recognized on a film. A number of spots allowing transmission of incandescent light was fourteen over the entire disc surface when visual check was executed. The defective rate was 5.3×10⁻⁵. Further, various performances were similarly evaluated again to those evaluated before the preservation as shown in the first table. Specifically, a jitter performance (data to clock jitter) was 7.5%, a modulation level was 0.66, a reflection rate was 18.9%, an average of PI error was 2.5, and the maximum of the PI error was 10. Thus, preferable performances were maintained without serious deterioration. Further, the content recorded by the MP 9120A was successfully read without error.

A second practical example is now described. A polycarbonate substrate with a wobbling guide groove having a diameter of 120 mm and a thickness of 0.6 mm was produced using an injection molding method. A bottom protection layer, a phase change recordation layer, a top protection layer, and a reflection layer were laminated on the substrate one after another using a sputtering method.

(ZnS)₈₀(SiO₂)₂₀, phase change recordation material of Ag₁Ge₂In₅Sb₆₇Te₂₅, (ZnO)₇₅(ZrC)₂₅, and a target of Ag₉₈Pt₁Pd₁ were used for the respective layers and underwent sputtering. Film thicknesses were 80, 20, 20, and 140 nm, respectively, in this order from the substrate side. A film formation time period for the top protection layer was 9.5 second. A sputtering rate was 20/9.5 (i.e., 2.1) nm/sec. An overcoat layer made of ultraviolet light curable type resin having an average film thickness of 6 micrometer was formed on the reflection layer using a spin coat method. Thereby, a single plate disc of a phase change type optical information-recording medium having DVD-ROM reproduction compatibility was produced. Then, a polycarbonate substrate having a thickness of 0.6 mm was laminated with the overcoat layer via an adhesive layer made of ultraviolet light curable type resin having an average film thickness of 50 micrometer using a spin coat method. Thereby, a lamination disc having a thickness of 1.2 mm was obtained. Then, the recordation layer was crystallized over the entire surface by an initialization apparatus having a large caliber LD (e.g. beam diameter: 100×1 micrometer) while executing constant liner velocity rotational control on conditions that a linear speed was 3 m/s, a feeding amount was 50 micrometer/round, and an initialization laser power was 750 to 800 mW.

Content data were then recorded into the thus obtained optical disc having the DVD-ROM compatibility using an optical information recordation apparatus capable of handling the DVD (e.g. the MP 5240A) at a linear speed corresponding to a DVD-ROM 2.4 times speed (i.e., 8.5 m/s). A performance of this recordation section was evaluated using a DVD reproduction evaluation apparatus (e.g. the CATS SA300) as shown in a table 2. Specifically, a jitter performance (data to clock jitter) was 6.8%, a modulation level was 0.65, a reflection rate was 21.2%, an average of PI error was 1.6, and the maximum of PI error was 7. Thus, recordation was preferably performed. Further, when the recorded content data were read from the optical information recording medium using the MP 9120A, data could successfully be read without error. Further, when an optical disc manufactured by the same condition was measured by a defection rate measurement apparatus, a defective rate was 3.9×10⁻⁵. Further, a number of spots allowing transmission of incandescent light was fifteen over the entire disc surface when visual check was executed. When these optical discs were preserved in a high temperature and humidity environment of 80 degree centigrade and 80% RH for 300 hours, and were visually checked, a black spot or the like caused by corrosion of the Ag reflection layer and a float or peeling off was not recognized on a film. A number of spots allowing transmission of incandescent light were twenty-six over the entire disc surface when visual check was executed. The defective rate was 4.7×10⁻⁵. Further, various performances were similarly evaluated again to those evaluated before the preservation as shown in the second table. Specifically, a jitter performance (data to clock jitter) was 7.1%, a modulation level was 0.65, a reflection rate was 19.4%, an average of PI error was 1.8, and the maximum of PI error was 8. Thus, preferable performances were maintained without serious deterioration. Further, reading of the content recorded by the MP 9120A was also successful without error.

A third practical example is now described. A polycarbonate substrate with a wobbling guide groove having a diameter of 120 mm and a thickness of 1.2 mm was produced using an injection molding method. A bottom protection layer, a phase change recordation layer, a top protection layer, and a reflection layer were laminated on the substrate one after another using a sputtering method. (ZnS)₈₀ (SiO₂)₂₀, phase change recordation material of Ag₂In₈Sb₆₅Te₂₅, (In₂O₃)₄₀(TeO₂)₄₀(SiC)₂₀, and a target of Ag₉₈Cu₁Pd₁ were used for the respective layers and underwent sputtering. Respective film thicknesses were 90, 20, 20, and 140 nm in this order from the substrate side. A film formation time period for the top protection layer was 7.1 second. A sputtering rate was 20/7.1 (i.e., 2.8) nm/sec.

Further, an overcoat layer made of ultraviolet light curable type resin having an average film thickness of 6 micrometer was formed on the reflection layer using a spin coat method. Thereby, a disc of a phase change type optical information recording medium (CD-RW) having a CD-ROM reproduction compatibility was obtained. Then, the recordation layer was crystallized over the entire surface by an initialization apparatus having a large caliber LD (e.g. beam diameter: 100×1 micrometer) while executing constant liner velocity rotational control on conditions that a linear speed was 5 m/s, a feeding amount was 50 micrometer/round, and an initialization laser power was 750 to 800 mW.

Content data were then recorded into the thus obtained optical disc having the CD-ROM compatibility using an optical information recordation apparatus capable of handling the DVD (e.g. MP 7120A manufacture by Ricoh CO, Ltd.,) at a linear speed corresponding to a CD-ROM 10 times speed (i.e., 12 m/s). Respective performances of this recordation section were evaluated using a CD recordation evaluation apparatus (e.g. CATS SA-3 manufactured by Audio Development Co, Ltd.) as shown in a third table. Specifically, a 3T jitter performance was 30 ns (a CD-RW standard is less than 35 ns), a modulation level was 0.64 (a CD-RW standard is more than 0.55), a reflection rate was 18.5% (a CD-RW standard is 15 to 25%), an average of CI error (BLER) was 3.2, and the maximum of CI error was 9 (a CD-RW standard is less than 220). Thus, recordation was preferably performed.

The recorded content data were read from the disc using an apparatus (e.g. the MP 9120A) capable of handling CD-ROM recordation, data could successfully be read without error. Further, when an optical disc manufactured by the same condition was measured by a defection rate measurement apparatus, a defective rate was 8.2×10⁻⁶. A number of spots allowing transmission of incandescent light was three over the entire disc surface when visual check is executed. When these optical discs were preserved in a high temperature and humidity environment of 80 degree centigrade and 80% RH for 300 hours, and were visually checked, a black spot or the like caused by corrosion of the Ag reflection layer and a float or peeling off was not recognized on a film.

A number of spots allowing transmission of incandescent light was six over the entire disc surface when visual check was executed. The defective rate was 9.4×10⁻⁶. Further, performances were similarly evaluated again to those evaluated before the preservation as shown in the third table. Specifically, a 3T jitter performance was 35 ns, a modulation level was 0.63, a reflection rate was 18.0%, an average of CI error (BLER) was 3.8, and the maximum of CI error was 12. Thus, preferable performances were maintained without serious deterioration. The content recorded by the apparatus (e.g. the MP 9120A) capable of handling reproduction of CD-ROM was successfully read without error.

A fourth practical example is now described. A polycarbonate substrate with a guide groove having a thickness of 1.1 mm was produced using an injection molding method. A reflection layer, a top protection layer, a phase change recordation layer, and a bottom protection layer were laminated on the substrate one after another using a sputtering method. Ag,(ZnO)₇₀(TiN)₃₀, Ag_{0.5}Ge₄In_{0.5}Sb₇₅Te₂₀, and a target of (ZnS)₇₀(SiO₂)₃₀ were used for the respective layers and underwent sputtering. Respective film thicknesses were 140, 10, 10, and 120 nm in this order from the substrate side.

A film formation time period for the top protection layer was 6.7 second. A sputtering rate was 10/6.7 (i.e., 1.5) nm/sec. Further, an overcoat layer made of ultraviolet light curable type resin having an average film thickness of 5 micrometer was formed on the reflection layer using a spin coat method. Then, a cover layer having thickness of 0.1 mm was adhered, thereby a phase change type optical information-recording medium (e.g. optical disc) having a thickness of 1.2 mm was obtained.

Then, the recordation layer was crystallized over the entire surface by an initialization apparatus having a large caliber LD (e.g. beam diameter: 75×1 micrometer) while executing constant liner velocity rotational control on conditions that a linear speed was 3 m/s, a feeding amount was 36 micrometer/round, and an initialization laser power was 600 to 650 mW.

Various performances of the thus obtained phase change type optical disc were evaluated using a recordation and reproduction evaluation apparatus (DDU-1000 manufactured by PULSETECH Industrial Co, Ltd.; Laser light wavelength λ of pickup=405 nm, NA of collimate lens=0.85).

First, a reflection rate was evaluated. The reflection rate was 19.8% as a corresponding value when a cover substrate having a thickness of 0.1 nm adhered to a pure Ag sputter film having a thickness of 1400 angstrom formed on a glass similar to an evaluation disc was used as a reflection rate comparative to an objective of 82.6% standard. Then, a mark was recorded with a density of 0.130 micrometer/bit onto an optical disc, and repetitious recordation and rewriting were evaluated on conditions that a clock frequency was 66 MHz, a recordation linear speed was 5.7 m/s, and recordation strategies includes equations of TSFP=1.77 ns, TEFP=2 ns, TMP=0.230 ns, and TLE=2.2 ns. As a result, an initial jitter of a repetitious jitter performance when an equalizer was used was 5.9%, and was changed and maintained to be 7.8% up to 1000 times. The initial modulation was 62%, and the modulation after 1000 times was 60%. A number of spots allowing transmission of incandescent light was twenty-two over the entire disc surface when the optical disc was visually checked. When the optical disc was preserved in a high temperature and humidity environment of 80 degree centigrade and 80% RH for 300 hours, and the jitter was measured again, the jitter performance showed changes less than 1% and thus was not a problem. A black spot or the like caused by corrosion of the Ag reflection layer and a float or peeling off was not visually recognized o a film. A number of spots allowing transmission of incandescent light was eighty-four over the entire disc surface when visual check was executed.

A first comparative example is now described. A polycarbonate substrate with a wobbling guide groove having a diameter of 120 mm and a thickness of 0.6 mm was produced using an injection molding method. A bottom protection layer, a phase change recordation layer, a top protection layer, and a reflection layer were laminated on the substrate one after another using a sputtering method.

(ZnS)₈₀ (SiO₂)₂₀, phase change recordation material of Ag₁Ge₃In₄Sb₇₂Te₂₀, (ZnS)₈₀(SiO₂)₂₀, and a target of Ag were used for the respective layers and underwent sputtering. Respective film thicknesses were 60, 15, 13, and 140 nm in this order from the substrate side. A film formation time period for the top protection layer was 4.3 second. A sputtering rate was 13/4.3 (i.e., 3.0) nm/sec. Further, an overcoat layer made of ultraviolet light curable type resin having an average film thickness of 6 micrometer was formed on the reflection layer using a spin coat method. Thereby, a single plate disc of a phase change type optical information-recording medium having a DVD-ROM reproduction compatibility was produced. Then, a polycarbonate substrate having a thickness of 0.6 mm was laminated with the overcoat layer via an adhesive layer made of ultraviolet light curable type resin having an average film thickness of 50 micrometer using a spin coat method. Thereby, a lamination disc having a thickness of 1.2 mm was obtained. Then, the recordation layer was crystallized over the entire surface by an initialization apparatus having a large caliber LD (e.g. beam diameter: 100×1 micrometer) while executing constant liner velocity rotational control on conditions that a linear speed was 11 m/s, a feeding amount was 36 micrometer/round, and an initialization laser power was 1300 mW.

Content data were then recorded into the thus obtained optical disc having the DVD-ROM compatibility using an optical information recordation apparatus capable of handling the DVD (e.g. the MP 5240A) at a linear speed corresponding to a DVD-ROM four times speed (i.e., 14 m/s). Respective performances of this recordation section were evaluated using a DVD reproduction evaluation apparatus (e.g. the CATS SA300) as shown in a fourth table. Specifically, a jitter performance (data to clock jitter) was 7.2%, a modulation level was 0.69, a reflection rate was 20.1%, an average of PI error was 3.1, and the maximum of PI error was 11. Thus, recordation was performed with a preferable performance. When the recorded content data were read from the optical disc using a DVD-ROM recordation apparatus (e.g. MP 9120A manufactured by Ricoh Co. Ltd.). Then, data could successfully be read without error. Further, when an optical disc manufactured by the same condition was measured by a defection rate measurement apparatus, a defective rate was 1.0×10⁻⁵. A number of spots allowing transmission of incandescent light was seven over the entire disc surface when visual check was executed. When these optical discs were preserved in a high temperature and humidity environment of 80 degree centigrade and 80% RH for 300 hours, and were visually checked, a float or peeling off was not recognized on a film. However, a black spot or the like was caused probably by corrosion of the Ag reflection layer. A number of spots allowing transmission of incandescent light was eight over the entire disc surface when visual check was executed. The defective rate was 2.7×10⁻⁴. Further, respective performances were similarly evaluated again to those evaluated before the preservation as shown in the fourth table. Specifically, a jitter performance (data to clock jitter) was 8.6%, a modulation level was 0.55, a reflection rate was 18.2%, an average of PI error was 124.7, and the maximum of PI error was 346.

Thus, performances were largely deteriorated. Further, reading of the content recorded by the DVD-ROM recordation apparatus (e.g. the MP 9120A) resulted in failure.

A second comparative example is now described. A polycarbonate substrate with a wobbling guide groove having a diameter of 120 mm and a thickness of 0.6 mm was produced using an injection molding method. A bottom protection layer, a phase change recordation layer, a top protection layer, and a reflection layer were laminated on the substrate one after another using a sputtering method.

(ZnS)₈₀(SiO₂)₂₀, phase change recordation material Ag₁Ge₂In₅Sb₆₇Te₂₅, Si₃N₄, and a target of Ag₉₈Pt₁Pd₁ were used for the respective layers and underwent sputtering. A film thickness was 80, 20, 25, and 140 nm respectively from the substrate side. A film formation time period for the top protection layer was 9.5 second. A sputtering rate was 25/9.5 (i.e., 2.6) nm/sec. Further, an overcoat layer made of ultraviolet light curable type resin having an average film thickness of 6 micrometer was formed on the reflection layer using a spin coat method. Thereby, a single plate disc of a phase change type optical information-recording medium having DVD-ROM reproduction compatibility was produced. Then, a polycarbonate substrate having a thickness of 0.6 mm was laminated with the overcoat layer via an adhesive layer made of ultraviolet light curable type resin having an average film thickness of 50 micrometer using a spin coat method. Thereby, a lamination disc having a thickness of 1.2 mm was obtained. Then, the recordation layer was crystallized over the entire surface by an initialization apparatus having a large caliber LD (e.g. beam diameter: 100×1 micrometer) while executing constant liner velocity rotational control on conditions that a linear speed was 3 m/s, a feeding amount was 50 micrometer/round, and an initialization laser power was 750 to 800 mW.

Content data were then recorded into the thus obtained optical disc having the DVD-ROM compatibility using an optical information recordation apparatus capable of handling the DVD (e.g. the MP 5240A) at a linear speed corresponding to a DVD-ROM 2.4 times speed (i.e., 8.5 m/s). When a performance of this recordation section was evaluated using a DVD recordation evaluation apparatus (e.g. CATS SA300 manufactured by Audio Development Co, Ltd.) as shown in a fifth table. Specifically, a jitter performance (data to clock jitter) was 7.4%, a modulation level was 0.63, a reflection rate was 20.1%, an average of PI error was 2.4, and the maximum of PI error was 13.

Thus, recordation was preferably performed. Further, when the recorded content data were read from the optical disc using a DVD-ROM recordation apparatus (e.g. the MP 9120A), data could successfully be read without error. When an optical disc manufactured by the same condition was measured by a defection rate measurement apparatus, a defective rate was 6.7×10⁻⁶.

Further, a number of spots allowing transmission of incandescent light was thirteen over the entire disc surface when visual check was executed. When these optical discs were preserved in a high temperature and humidity environment of 80 degree centigrade and 80% RH for 300 hours, and were visually checked, a black spot or the like caused by corrosion of the Ag reflection layer or the like was not recognized. However a float or peeling off was recognized on a film. There were myriad of spots allowing transmission of incandescent light over the entire disc and it was impossible to count when visual check was executed. The defective rate was 3.8×10⁻³. Further, various performance were similarly evaluated again to those evaluated before the preservation. The result shows in the fifth table. Specifically, a jitter performance (data to clock jitter) was 8.9%, a modulation level was 0.60, a reflection rate was 18.5%, an average of PI error was 220.4, and the maximum of PI error was 563. Thus, performances were largely deteriorated.

Reading of the content data recorded by the DVD-ROM reproduction apparatus (e.g. the MP 9120A) resulted in failure.

Numerous additional modifications and variations of the present disclosure are possible in light of the above teachings. It is therefore to be understood that within the scope of the appended claims, the present disclosure may be practiced otherwise that as specifically described herein.

This application claims priority under 35 USC § 119 to Japanese Patent Application No. 2005-078101 filed on Mar. 17, 2005, the entire contents of which are herein incorporated by reference.

What is claimed is:

1. A phase change optical information-recording medium comprising;
a substrate including a wobble, guide groove having one of a concentric shape and a spiral shape;
at least a bottom protection layer, a recordation layer, a top protection layer, and a reflection layer, each of said layers formed on the substrate one after another, a phase of said recordation layer being changed by a laser light when information is recorded or rewritten;
wherein said reflection layer mainly includes at least Ag, and said top protection layer includes oxide as a main component and one of nitride and carbide.

2. The phase change optical information recording medium as claimed in claim 1, wherein said oxide includes an element having binding energy of 90 kj/mol for binding the element and oxygen.

3. The phase change optical information recording medium as claimed in claim 1, wherein said oxide includes one of ZnO, In₂O₃, and TeO₂.

4. The phase change optical information recording medium as claimed in claim 1, wherein content of said oxide is more than 50 mol %.

5. The phase change optical information recording medium as claimed in claim 1, wherein said nitride includes an element having binding energy of more than 100 kj/mol for binding the element and nitrogen.

6. The phase change optical information recording medium as claimed in claim 1, wherein said nitride includes one of Si₃N₄, TiN, and ZrN.

7. The phase change optical information recording medium as claimed in claim 1, wherein said carbide includes an element having binding energy of more than 100 kj/mol for binding the element and carbon.

8. The phase change type optical information recording medium as claimed in claim 1, wherein said carbide includes one of SiC, TiC, and ZrC.

9. The phase change type optical information recording medium as claimed in claim 1, wherein a defective rate is not more than 1.0×10⁻⁴ when said phase change type optical information recording medium is left in an environment in which temperature is 80+/−2 degree Centigrade and relative humidity is 85+/−5% for about 300 hours.

10. The phase change type optical information recording medium as claimed in claim 9, wherein an increase rate of said defective rate is less than three times.

11. The phase change type optical information recording medium as claimed in claim 1, wherein an increase rate of said reflection layer mainly including at least Ag is less than three times.

12. The phase change type optical information recording medium as claimed in claim 1, wherein an increase rate of data recordation error is less than three times.

13. The phase change type optical information recording medium as claimed in claim 1, wherein information representing that the maximum recordation linear speed is more than 12 m/s is stored.

14. The phase change type optical information recording medium as claimed in claim 1, wherein a film thickness of said top protection layer ranges from about 5 nm to about 40 nm.

15. The phase change type optical information recording medium as claimed in claim 1, wherein said top protection layer is formed from a target having substantially the same material ratio as a sputtered top protection layer formed by a sputtering method.

16. The phase change type optical information recording medium as claimed in claim 15, wherein a sputtering rate ranges from about 1 to about 6.25 nm/s.

17. A phase change optical information-recording medium comprising;
a substrate including a wobble guide groove having one of a concentric shape and a spiral shape;
at least a bottom protection layer, a recordation layer, a top protection layer, and a reflection layer, each of said layers formed on the substrate one after another, a phase of said recordation layer being changed by a laser light when information is one of recorded and rewritten;
wherein said reflection layer mainly includes at least Ag, and said top protection layer mainly includes at least two types of oxide and one of nitride and carbide.

18. The phase change optical information recording medium as claimed in claim 17, wherein said at least two types of oxide include an element having binding energy of more than 90 kj/mol for binding the element and oxygen.

19. The phase change optical information recording medium as claimed in claim 17, wherein said at least two types of oxide include one of ZnO, In₂O₃, and TeO₂.

20. The phase change optical information recording medium as claimed in claim 19, wherein content of said at least two types of oxide is not less than 50 mol %.

21. A phase change optical information-recording medium comprising;
a substrate; and
at least a bottom protection layer, a recordation layer, a top protection layer, and a reflection layer, each of said layers formed on the substrate in that order,
wherein said reflection layer mainly includes at least Ag, and said top protection layer includes oxide as a main component and one of nitride and carbide.
